(19) United States
(12) Patent Application Publication
(10) Pub. No.: US 2011/0020568 A1
(43) Pub. Date: Jan. 27, 2011

(54) METHOD FOR WOOD HEAT TREATMENT AND A DEVICE FOR CARRYING OUT SAID METHOD

(76) Inventor: Igor Aleksandrovich Danchenko, Monroeville, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/921,942

(22) PCT Filed: Mar. 28, 2007
(86) PCT No.: PCT/RU07/00147

§ 371 Date: Sep. 10, 2010

(51) Int. Cl. F26B 3/00

(52) U.S. Cl. 428/17; 34/391; 34/62

(57) ABSTRACT

The group of inventions relates to a method and a device for wood heat treatment and can be used for building and in the wood work and timber and furniture industries. The inventive method consists in controlling a heat-treatment process by forming control actions corresponding to parameters of current information inputted in the form of control signals into a computer system for determining the optimal values of the process parameters. The inventive device comprises a control cabinet which is provided with a computer system for controlling and programming a process and is connected to electrically driven shutters. Said invention makes it possible to improve the quality of treatable wood.

### PURPOSE OF THE INVENTION

The invention relates to the wood-processing industry and the methods to improve the mechanical and chemical properties of wood and wood-based materials and may be used to produce various insulation and construction materials (particularly, doors, windows, and flooring) in the home-furnishing industry.

### PRESENTATION OF THE INVENTION AND THE CURRENT STATE OF THE ART

Expansion of wood in a liquid medium and its susceptibility to the effects of fungi and various biological attacks have given rise to studies for the purpose of increasing its stability and limiting the absorption of moisture.

A number of methods to increase the qualitative indices of wood by means of preventive plastic lamination and the resultant increase in density are known. Until recently, the most advanced method was plasticization based on prior processing of the wood with gaseous ammonia or other chemical reagents.

Accordingly, a method is known from SU 140560 (1961) to modify wood, according to which the wood is placed into a 21˜25% ammonia solution at a temperature of 15˜20° C. and is kept there for up to 12 days, and then it is removed from the solution and is mechanically compressed at standard temperature and final specific pressure of approximately 80 kg/cm².

The shortcomings of this method include a low degree of dimensional stability of the compressed wood in water, a high degree of water absorption, a low degree of surface hardness, and the length of time required for the process.

A method is known from SU 971653 (Nov. 7, 1982) to produce modified wood that includes processing of the wood with ammonia and a mixture of oxygen and urea and subsequent thermal treatment, during which phosphoric acid is used as oxidizer that is dissolved in water along with the urea at a concentration of 1.5˜2.5 mol/liter of acid and 5˜7 mol/liter of urea, after which the wood is dried to 5˜15% moisture content, is thermally treated at a temperature of 140˜190° C., and with compression by 5˜40% of its initial volume.

This known method also does not allow production of modified wood with a high degree of dimensional stability in water and a low degree of water absorption.

A method is known from RU 2109626 (Apr. 7, 1998) of altering the physical and mechanical properties of wood, according to which the wood is placed into a hermetically-sealed chamber. Partial vacuum of 0.03 MPa is created within the chamber by pumping out the air with a vacuum pump. After the air is extracted, gaseous ammonia is injected into the chamber under pressure and the wood is subsequently heated to 80˜85° C. by means of heating the chamber with steam. After this, the wood is chemically processed by means of inducing circulation of the gaseous ammonia mixture within the chamber. The pressure, partial vacuum, and temperature within the chamber 1 are monitored using a manometer, vacuum gauge, and thermometer, respectively. After this ammonia-treatment process is complete, the pressure within the chamber is reduced to atmospheric pressure (0.1 MPa). After atmospheric pressure is attained within the chamber, partial vacuum is created down to a pressure of 0.03 MPa. The pressure within the chamber is then raised again to atmospheric pressure by adding compressed air. After the necessary moisture content is achieved, the wood is ready for thermal treatment, during which the wood is heated to 110˜120° C. and held at that temperature for 1˜5 hours. After thermal processing is complete, the wood and the chamber are cooled to 40˜50° C., and the wood is removed from the chamber.

A disadvantage to this known method is the increased consumption of gaseous ammonia, and the concomitant increase in energy consumption required to treat a unit of wood.

A method is known from SU 1303797 (1985) for dielectric processing of wood within an electrical field by means of its alternating displacement between a pair of capacitor plates.

The disadvantage of this method is the non-uniform drying of the wood and the high level of energy required.

Methods are known from SU 937928 (1980) and from RU 2079074 (May 10, 1997) to dry materials, particularly wood, by applying a super-high frequency (SHF) field from one or more SHF generators onto the material to be dried.

The disadvantages of these methods are the non-uniform drying of the wood and the high level of energy required.

Recently, various methods of thermal and moisture processing of wood, wood-based materials, and a wide variety of wood products have found wide application in wood processing.

There is a known method to treat wood by accelerating its aging, including maintaining the batch at a temperature of 110˜190° C. for 10˜48 hours and subsequent treatment of the batch with a hydrogen peroxide solution at a concentration of 10˜15% for 12˜15 hours (SU 719870, 1980). This known method may be successfully applied to accelerate aging of the wood batch intended for preparation of high-quality musical instruments and for renovation/restoration purposes.

A method is also known to treat wood that includes heating the wood within a chamber to an initial temperature that is lower than the vaporization temperature of the moisture contained within the wood at initial chamber pressure, subsequent reduction of pressure within the chamber, and extraction of the moisture produced (RU 2145693, 2000). According to this method, the wood is heated to achieve a chamber pressure of no less than 2 atm at a temperature of 120˜200° C. When the pressure is raised, for example to 8 atm, the wood of coniferous species acquires a brownish color shade.

A method is also known to surface-treat wood products by means of thermal processing that consists of heating the products in atmospheric air, maintaining the temperature at 190˜230° C. for 1.5˜4 hours, and subsequent cooling the products under natural conditions (RU 2099180, 1997). As a result, the wood acquires a sharply-patterned texture, and its appearance is not inferior to more valuable tree species.

A method is also known from SU 1250460 (1986) to treat wood that includes advance heating of the wood structure by means of heated air and subsequent exposure to wet steam. In this method, the advance heating of the wood structure is performed by heated air at a temperature of up to 100° C. The air is then replaced with wet steam at a temperature of 220˜240° C., and this temperature is maintained for no less than 2 hours.

However, all these known methods of the so-called thermal treatment of wood, during which its coloration is altered, are mainly intended to treat wood of lower-cost tree species (aspen, linden, conifers, etc.). When these known thermal-treatment methods are used on hard woods, it is not possible to achieve coloration across the entire cross-section of the treated wood of thickness exceeding 20˜35 mm or to avoid cross-section cracks, particularly in thick materials. Also, the average level of residual moisture content of the wood treated using these known thermal-treatment methods is inconsistent and remains at 4˜15%.

A device for drying wood is known that includes a drying chamber into which a stack of wood is placed, air inlet and outlet ducts, heating elements, a ventilator, and a humidifying device (RU 2023963, 1994). This known device is intended to dry wood of hardwood species at a maximum temperature of the thermal medium (wet steam) not to exceed 85° C. Therefore, the wood is not heated above the temperature of its interaction with the oxygen in the ambient air, at which point the wood would ignite.

A device is also known for drying wood with a chamber that includes jets mounted to provide heated air to the stack of wood (SU 94719, 1960). In order to alter the condensation speed of the steam within the chamber of this known device, one of its walls is made of heat-conducting material that is covered on its exterior with folding ceramic cushions. This provides the opportunity to regulate the drying speed. However, in this known device, non-uniform heating of the stack of wood occurs along its length, which is the result of non-uniform distribution of heated air along the length of the stack due to reduced pressure at the jets combined with increased distance from the ventilator and changing position.

A device is also known from RU 2182293 (2002) to treat wood that includes a chamber with an area provided for the stack of wood, heating elements, and a fan to circulate the thermal medium located within the chamber that includes inlet and outlet. A container is positioned in this known device in the area provided for the stack of wood that includes racks to hold the products to be treated, or the container may be equipped with separators positioned between the layers of wood forming the stack. The opposing walls of the container, for example the floor and ceiling, are provided with apertures whose cross-sectional area is proportional to the cross-sectional area of the inlet and outlet apertures of the system providing circulation of the thermal medium filling the chamber. In this way, uniform distribution of the medium filling the chamber is ensured along the length of the stack of wood. But on the other hand, the presence of the walls does not allow complete uniformity of the medium distribution in the chamber in the course of processing the stack of wood, and the resistance of the medium filling the chamber increases during its circulation within the chamber.

A method and device to process wood are known from RU 2235636 (Sep. 10, 2004). This known method includes advance heating of the wood in a chamber by means of heated air within the chamber and subsequent exposure to wet steam. Heating the air within the chamber occurs at a rate of 30˜45 degrees Celsius per hour to a temperature of 130˜165° C., then the wet steam acts on the wood for 0.5˜1.75 hours, after which heating of the steam-gas medium occurs within the chamber at a rate of 4˜8° C. per hour to a temperature of 160˜200° C., then wet steam acts on the wood for 0.5˜1.75 hours, after which heating of the steam-gas medium occurs within the chamber at a rate of 4˜8° C. per hour to a temperature of 160˜200° C., the wood is held at that temperature for 2.5˜6 hours, and then wet steam acts on the wood for 0.5˜1.75 hours, after which heating of the steam-gas medium takes place within the chamber at a rate of 4˜8° C. per hour to a temperature of 160˜200° C., then the heating of the steam-gas medium is halted, and 1˜3.5 hours after the heating of the steam-gas medium within the chamber has been discontinued, wet steam acts on the wood for 0.5˜1.75 hours, for which the action of wet steam on the wood is performed by injecting wet steam into the chamber at a temperature from 120° C. to 160° C., and the steam-gas medium is extracted from the chamber. This described known method is performed within a device for wood treatment that includes a chamber with an area provided for stacks of wood, heating elements, and a fan to circulate the thermal medium that is within the chamber, including an inlet and an outlet, and the chamber is divided by at least one partition into two cavities with the option of having the medium flow from one cavity into the other through the area provided for the stacks of wood. The inlet for the fan to circulate the thermal medium is hydraulically connected with one cavity, and the outlet with the other, so that the thrust N of the thermal-medium circulation fan is obtained from the condition:

$$N = ( {K}_{1} + {K}_{2} ) \frac{{V}_{sh}}{{V}_{p}}$$

Where Vₛₕ=volume of wood stack, m³;

Vₚ=volume of cavities, m³;

K₁=0.437 (experimentally-established coefficient, kPa);

K₂=5.62 (experimentally-established coefficient, kPa).

Even though this known method and device to treat wood with steam provide the opportunity to process wood with a thickness greater than 200 mm, to widen the scope of tree species whose wood is subjected to thermal treatment and to obtain wood with improved properties, it is not without certain difficulties connected with the necessity of maintaining within strict limits a large number of parameters related to the temperature, the processing time at each stage, and the rate of the steam-gas medium being fed.

A method is known to process wood that includes its gradual heating in a medium of wet steam and air. The wet steam is required to prevent the ignition of the wood (Review of Heat Treatments of Wood, Proceedings of Special Seminar held in Antibes, France on Feb. 9, 2001, pp. 2˜5).

As a result of the use of this method, the physical and chemical properties of the wood are altered. The thermal treatment darkens the color, reduces the shrinking and expansion of the wood, and improves the uniformity of the water content. The resistance to rotting is increased, and the sensitivity to attack by molds is reduced. However, the presence of air may lead to excessive oxidation of the wood and extreme danger of self-combustion during the maximum processing temperature, and to excessive blackening and destruction during processing.

A method is known to process wood that includes its gradual heating and subsequent cooling. This process is performed at least during the cooling stage with no oxygen present, in a nitrogen atmosphere (French patent No. 2786426, 2000).

The use of this method also permits improvement of physical and chemical properties of the wood. However, the total lack of any modifying agents in the nitrogen atmosphere does not allow provision of several useful wood properties that it might have after treatment in a suitable atmosphere.

This patent application claims a group of inventions that are further improvements by the author/applicant to known methods and devices for thermal treatment of wood described in RU 2277045 (May 27, 2006), whose author and claimant is the author of the claimed group of inventions.

This known patent RU 2277045 describes a method for thermal treatment of wood to improve its basic properties and a device for its implementation. The method includes heating the wood to 140˜150° C. in ambient air atmosphere for 2˜3 hours, further heating of the wood in an atmosphere of wet steam to 210˜220° C. for 2˜3 hours, which is performed by means of constant, metered injection of water into the chamber and displacement of the air and other gases from the chamber forming the wet steam, self-heating to 230˜240° C. for 30˜60 minutes, discontinuing the self-heating by means of controlled injection of water, and cooling of the wood in an atmosphere of 100% super-saturated wet steam by means of controlled injection of water.

The device described includes for its implementation a body that is thermally insulated from ambient air, with an aperture that may be hermetically sealed to emplace the wood that is positioned within the body of the chamber connected via air ducts with a high-temperature heating ventilator for pumping in the air, a scrubber to clean the exhausted air mixture, a control unit for air heating control, including air tubular heating elements and controlling thermocouples—sensors to measure and monitor the temperature whose signals are fed to the control cabinet connected with the injecting mechanism for metered injection of water connected with the chamber, and a heating unit and ventilator.

This known method and the device to implement it allows improvement of the basic properties of the wood being processed—moisture repellency, geometric stability, and resistance to biological attack. However, in view of the increased requirements to the quality of thermally-treated wood, the known method and device described by the author/applicant in the previous patent RU 2277045 did not completely ensure the stability of all properties of the wood that has undergone thermal treatment for the purpose of improving its basic properties because, in particular, the required corrections have not been made in full to the process parameters dependent on the type and quality of the initial material, the variation in process conditions, and the required quality level of the finished product—in this case thermally-treated wood.

The known RU 2070692 (Dec. 20, 1996) describes a method to dry dielectric materials, particularly particle materials, according to which SHF thermal processing is performed of materials placed on a conveyor within a drying chamber with convective heating by means of hot air, for which monitoring of parameters of the material being dried is performed, the level of SHF power is regulated by changing the operating mode of the source of SHF power, during which the ratio of the power levels of the heating element and the SHF source is maintained in accordance with the expression

$$\frac{{P}_{conv}}{{P}_{shf}} = \frac{2 nr}{{R}_{μ} {C}_{p} d} {e}^{- kd} ,$$

Where

P_{conv}=power applied to the material's surface (power output of heating element),

P_{shf}=power output of SHF source,

n=coefficient based on material type

r=latent heat of steam formation,

Rμ=hydraulic resistance of a layer of material with a thickness equal to d/2,

d=thickness of material,

r=average density of material,

k=coefficient of absorption of SHF energy by the material,

C=average specific thermal capacity of the wet material.

An attempt to regulate the parameters of the process depending on the type of initial material and other set conditions has been made in the invention for the purpose of controlling the parameters of the material to be dried.

However, even this method is not without shortcomings, which are related particularly with the use of SHF energy and with the impossibility of operationally regulating the parameters of the process dependent on a change of a specific condition.

Therefore, the technological task of this group of inventions is to ensure stability of the basic properties of thermally-treated wood based on the possibility for operational auto-regulation of process parameters.

### DISCLOSURE OF THE INVENTION AND A BRIEF DESCRIPTION OF ITS NATURE

Thus, the tasks whose resolution this invention is intended to provide are the creation and further improvement of a method and device for wood treatment that ensures attainment of a wood structure with stable, improved properties, allowing expansion of its scope of applicability.

As a result of resolving this technical task, it has become possible to attain technical results that include a stable improvement of such basic properties of wood as its water repellency properties (reduction of the average level of the residual moisture content of the thermally-treated wood, reduction of the equilibrium moisture content, improved uniformity of the wood structure, and improved stability of its geometry and resistance to biological attack).

This technical task that has been set forward is solved by the claimed group of inventions which includes a method of thermal treatment of wood and a device for its implementation.

Thus, the set task is solved by a method of thermal treatment of wood to improve its basic properties. It includes heating wood to 140˜150° C. in ambient atmosphere, subsequent heating of the wood in a wet-steam atmosphere up to 210˜220° C. accomplished by means of constant metered injection of water into the chamber and forcing the air and other gases out of the chamber by means of the wet steam formed there, self-heating to 230˜240° C. for 30˜60 minutes, discontinuing the self-heating by means of metered injection of water and cooling the wood in an atmosphere of 100% super-saturated wet steam by means of controlled water injection, whereby the control and programming of the thermal-treatment process modes is performed by using the principle of intellectual cycles, during which control of the thermal-processing cycle takes place by the generation of control actions, which correspond to the parameters of the current input information used, in the form of control signals to a computer system that determines the optimum values of process parameters.

These control actions (control signals) correspond to the thermal treatment process parameters and include the temperature values of the thermal medium, the temperature of the wood at various points of the stack at inlet and outlet, the wood species, the dimensions of the lumber (and of the stack), the addition of air and water, the control of the steam feed, and the duration of the process.

To this purpose, in the implementation of this method, the pressure of the wet steam within the chamber is set to 10% above atmospheric pressure.

Particularly, heating of the wood to 140˜150° C. in ambient atmosphere is performed for 2˜3 hours.

Particularly, further heating of the wood in a wet-steam atmosphere to 210˜220° C. is performed for 2˜3 hours.

In the claimed invention, the first employed method of controlling the processing cycle uses as control signals not only the temperature value of the heat-transfer medium, but also the values of the result of heating the wood at various points of the stack. As a result, the duration of the cycle becomes a floating parameter, and it depends on processes occurring during the treatment process. Such a cycle with the method of its implementation is tentatively called an intellectual cycle. In order to control this process, variable average temperature values of the wood are used at the inlet and outlet of the air flow which is the heat-transfer medium. The values of the attained parameters are programmed by the operator and depend on the desired level of processing, the wood species, the initial dimensions of the wood, and other parameters. Such a method of controlling the cycle allows control of thermal reactions occurring during processing of deciduous wood, which allows attainment of the expected result independently of the dissipation of the parameters of the source raw material. This treatment method advantageously distinguishes WESTWOOD from worldwide competitors (mainly Finnish) that perform process control based on the temperature of the heat-transfer medium, as a result of which the portion of the deciduous wood in production using Finnish equipment necessarily barely reaches 15%.

The technical task is attained also by a device for thermal treatment of wood that operates on the principle of an intellectual cycle and that includes a hermetic thermally-insulated chamber positioned within a sea container and having a hermetically-sealable aperture through which to load the wood, connected by a connecting hose with air ducts, a ventilator to force the air, a vaporizer and electrical heating unit, a water-feed metering pump connected with the vaporizer, electrically-driven flow-control valves connected with the chamber, a scrubber for the mixture of steam and air connected with the chamber by means of a hydraulic lock, a control cabinet with a computer system for control and programming the process and for controlling the electrical heating unit, electrically-driven flow-control valves, a metering pump, a chamber equipped with sensors to monitor process parameters with the control signals generated by the sensors that are provided to the control cabinet.

For this purpose, the device includes a perforated wall positioned within the chamber in parallel to its walls.

For this purpose, there is a loading aperture in this device in the form of a thermally-insulated door.

### DETAILED DESCRIPTION OF THE NATURE OF THE INVENTION

A method for thermal treatment of wood to improve its basic properties, including heating the wood to 140˜150° C. in ambient atmosphere, subsequent heating of the wood in a wet-steam atmosphere to 210˜220° C., which is accomplished by means of continuous metered injection of water into the chamber and forcing the air and other gases out of the chamber by means of the wet steam being formed, self-heating to 230˜240° C. for 30˜60 minutes, discontinuing the self-heating by means of metered injection of water, and cooling the wood in an atmosphere of 100% super-saturated wet steam by means of metered injection of water. During this, control and programming of the thermal-treatment process modes using the principle of an intellectual cycle is performed, in which the control of the thermal-treatment cycle is formed by control actions corresponding to the parameters of the current information that is entered in the form of control signals into a computer system that determines the optimum values of the process parameters.

Processing temperature and duration depend on the necessity of attaining a particular material property. The maximum temperature and a graph of its progression depend on the species and the quality of the initial material and may be selected by the user. During the treatment process, the temperature is maintained automatically by means of the pertinent program.

Heating of the wood to 140˜150° C. in ambient atmosphere is projected to require 2˜3 hours.

Subsequent heating of the wood in a wet-steam atmosphere to 210˜220° C. is projected to require 2˜3 hours.

Pressure of the wet steam within the chamber is preferred to be 10% above atmospheric pressure.

Wood obtained using this method is tentatively called WESTWOOD (from the phrase Water Extruding Stabilized Wood).

This task was resolved also by another invention of the claimed group - a device for thermal treatment of wood operating on the principle of an intellectual cycle.

The system for thermal treatment of wood consists of a hermetic thermally-insulated chamber 1 positioned within a container on whose opposite side various fittings are positioned. The material to be processed is loaded as a stack 3 on a metallic support and is driven into the chamber 1 on rails by means of a hydraulic cart. The hydraulic cart is removed from the chamber 1 of the system during processing.

The access aperture to the chamber 1 is sealed by a hermetic door that is pressed into place against the body of the chamber using threaded fasteners and closers ensuring the air-tightness of the chamber.

The air from the chamber 1 is extracted through an air-collection channel 2 and a connecting hose by means of a ventilator 4 of the system and is forced into an air-preparation chamber where it is continuously pumped into the vaporizer 5 and the electrical heating unit 7. The air heated within the heating unit returns to the chamber 1 via the connecting hose and transfers its heat to the processed material.

When a temperature of 120° C. is reached, the solenoid metering pump 6 is placed into action. It provides a metered quantity of water from the pump supply tank to the vaporizer 5. The steam formed gradually forces the air out of the chamber 1. The remaining mixture of steam and air is extracted by means of the hydraulic lock 8 and the scrubber 9 and is then released to the atmosphere. The condensation of the redundant steam and the dissolving of the remaining residues of the products of wood distillation take place in scrubber 9.

When the temperature within the chamber drops below 80° C., the water supply by the metering pump 6 ceases automatically and the electrically-driven flow-control valves 10 automatically open. The steam is removed from the chamber through one of them, and fresh air is pumped through the other into the chamber.

Control of the electrical heating unit, the electrically-driven flow-control valves, the metering pump, etc. is provided from the control cabinet 11 that includes a liquid-crystal display (LCD) to monitor and program the processes. Along with the previously-mentioned signals from various sensors, the control cabinet also receives temperature signals at various locations within the stack of wood being treated. Programming of control modes of the cycle is performed based on the values of above-mentioned parameters, the attainment of which is a control signal to control the cycle. Switching of power circuits is performed by means of the power cabinet (not shown in illustration) (see FIG. 5).

Treatment of the wood occurs at increased temperature in the total absence of air, but in the presence of wet steam. For this purpose, the water, as might be supposed, plays a role not only as a cooling agent but also as a modifier. As a result of the thermal treatment using this method in an atmosphere of super-saturated wet steam at temperatures significantly above 100° C., hydrogen atoms from the wet steam combine with the molecules, of which the wood consists, by forming new bonds. Also, heating the wood above 160° C. leads to ‘twisting’ of the linear molecules of the wood into ‘rings’. As a result, water molecules cannot combine with molecules located within such a ‘ring’, and this is an additional factor preventing the wetting of the wood (which occurs, however, during any thermal treatment of wood above 160° C.). In our process, as a result of reinforcement of the hydrogen atoms on the exterior of a ‘ring’, they not only form additional protection against penetration of water molecules within such ‘rings’, but also completely prevent the approach of water molecules to wood molecules. When the treated wood is used in wet conditions, water molecules are repelled from the wood (which leads to the ‘anti-wetting’ effect), as a result of which water penetrates into wood treated by the proposed process only minimally, and this is only because of the porous structure of the wood itself, and not because of wetting. Water evaporates easily from the wood. This property of repulsion of water at the molecular level in wood treated by this method retards the ‘swelling’ effect of the material found in untreated wood.

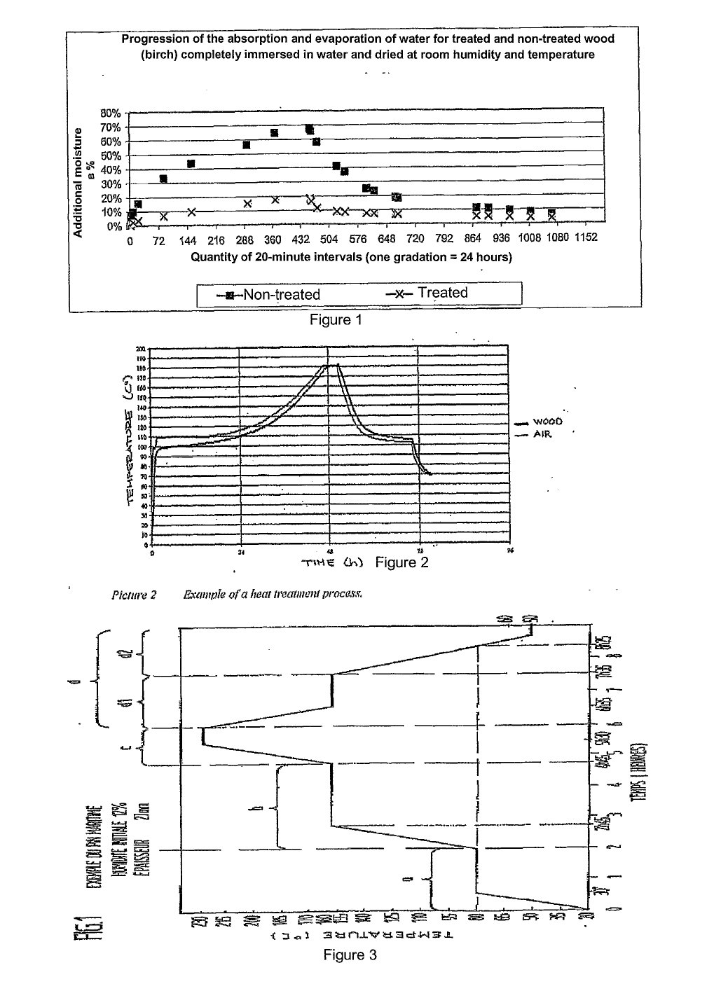

FIG. 1 shows the results of an experiment on the progression of water absorption by treated and untreated wood (the wood was immersed in water for almost 7 days and was subsequently dried at room temperature). The treated wood gained 18% moisture in contrast to 70% for the untreated wood.

When this method is applied, the geometry of the wood acquires improved stability. This property of wood is achieved because of the structuring of the molecular bonds of the wood and acquisition by them of additional stiffness because of volatilization and disintegration of the high-molecular compounds (resins). In the experiment, the treated wood practically did not change its dimensions (increase of 1%) in comparison with untreated wood which ‘swelled’ by 17%.

Wood treated by this method also acquires increased resistance to biological attack. The high processing temperatures decompose the polysaccharides in the wood which, against the background of its very low moisture content of 2˜4% (wood at high processing temperatures also releases the water contained at the molecular level), creates almost absolute resistance to attack by molds or other micro-organisms of any wood processed at high temperature.

As may be understood from comparisons with, for example, Finnish and French methods of thermal treatment, the proposed method possesses a number of principal differences:
An atmosphere of super-saturated steam is used as an inert medium (in one known method, nitrogen is used as an inert medium after total extraction of the oxygen, and in another known method, steam is used to prevent combustion in a mixture with air).
Controlled injection of water is used not only to generate the steam medium, but also for controlled cooling during the cycle of emergence from the high temperatures (upon evaporation, water absorbs energy from the ambient air, leading to its cooling).

During the heating cycle, a controlled exothermic -chemical reaction is used that occurs when the wood is at a temperature of 210˜220° C., and that leads to additional heating of the wood with respect to the heated air. As may be seen from the graph of the Finnish process (FIG. 2), during the heating stages, the air is at a higher temperature, but during the cooling stage it is lower because the temperature does not attain the 210° C. required to initiate the exothermic chemical reaction, and the effect of raising the temperature of the wood above that of the air is not observed and is not used.

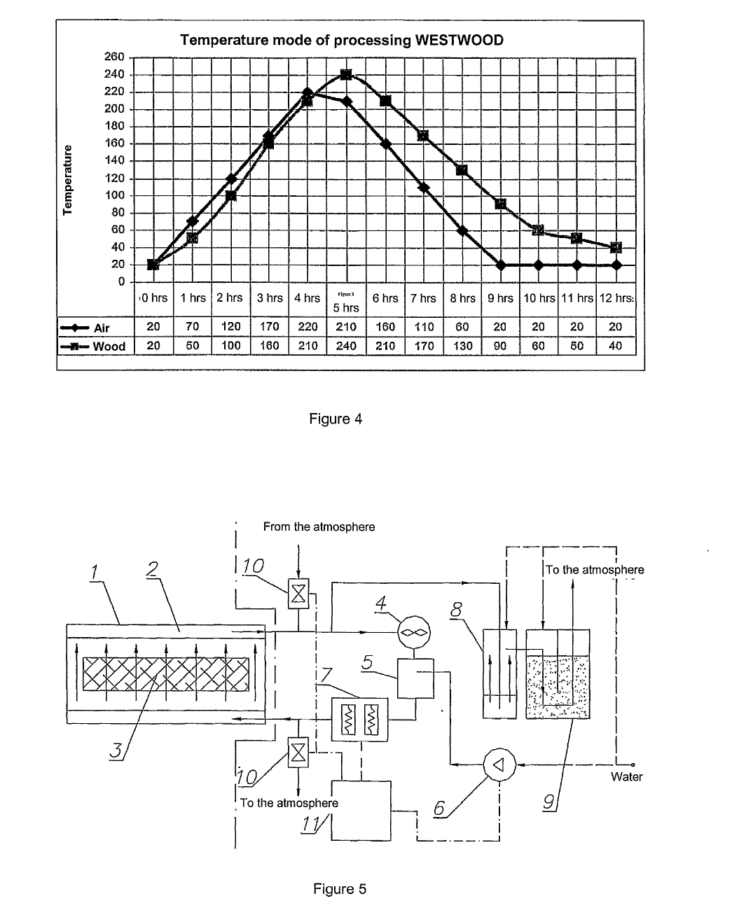

In the claimed method, the exothermic chemical reaction is used since the heating mode is selected on its basis (when the wood temperature drops below 210° C., the reaction ceases). Thus, the processing mode within an atmosphere of super-saturated wet steam plus the exothermic chemical reaction is essentially a new technology not employed until now. The graphs enclosed below show the thermal modes of heating and cooling used during retification (FIG. 3) and according to the claimed method (FIG. 4).

Thus, a series of effects (directed actions) is used to produce wood according to the claimed method:
High-temperature super-saturated wet steam obtained as the result of controlled injection of water at specific stages of the processing cycle.
Gradual (automatically regulated) slow heating of the air medium within the chamber to a temperature of 210˜220° C. This leads to a controlled exothermic chemical reaction within the wood that occurs at a temperature of 210° C. and that leads to additional heating of the wood to a temperature of 230˜240° C. (by 20˜30° C. hotter than the temperature of the ambient air).
Gradual (automatically regulated) slow cooling of the ambient air within the chamber as a result of controlled injection of water into the chamber (which causes cessation of the reaction) from a temperature of 210˜220° C. to 20° C.
Inert processing medium consisting of 100% super-saturated wet steam created during the heating stage at temperatures above 150° C. and during the cooling stage down to temperatures of 80˜100° C. injected at a low positive pressure, which leads to complete expulsion of the air from the processing chamber. The original programmed processing mode, which includes a stage of gradual heating (4 hours), leads to the initiation of the exothermic chemical reaction that supports the air temperature at 210˜220° C. (0.5˜1 hour depending on the desired level of processing) and then to a cooling stage by means of controlled injection of water (6˜7 hours).

The invention is illustrated by the following figures:

FIG. 1 shows the progression of the absorption and evaporation of water by treated and non-treated wood (birch) completely immersed in water and dried at room humidity and temperature.

FIG. 2 shows a graph of the thermal progression of processing the wood using a known method.

FIG. 3 shows a graph of the thermal progression of heating and cooling used during processing of wood using a known method.

FIG. 4 shows the thermal progression of wood using the claimed method.

FIG. 5 shows a schematic diagram of the claimed device.

Operation of the claimed device and implementation of the method are illustrated by the following implementation examples that do not limit the invention.

### IMPLEMENTATION EXAMPLE 1

Wood (dry, sawed lumber, birch 50 mm thick, 3 m long, and 150 mm wide) is stacked on the cart on pallets and is covered with stacked cross-cut laths of the same material with a thickness of 30 mm. The thermally-insulated door is opened, the cart with the pallet is driven into the chamber 1, and then the door is closed by means of a clamping device (not shown in the illustration). Two modes can be specified by means of the control cabinet 11—a processing mode—rate of heating for the given wood species (birch), and a temperature mode to attain a particular stage of processing (maximum temperature and holding times at that temperature). The following values are programmed: heating air to 140° C. over 3 hours. The control cabinet 11 includes a PUSK (LAUNCH) pushbutton that switches on the ventilator 4. The air from the chamber 1 is extracted by the system ventilator via the air-collection channel 2 and the connecting hose and forced into the air-preparation chamber, from where it is subsequently pumped into the vaporizer 5 and the electric heating unit 7. The air heated by the heating unit returns to the chamber 1 via a connecting hose providing heat to the material being processed.

When the air reaches 120° C., the solenoid-operated metering pump 6 is activated. It adds a metered quantity of water from the pump supply tank to the vaporizer 5. The formed steam gradually displaces the air from the chamber. The remaining steam and air are forced out by through the hydraulic lock 8 into the scrubber 9 and then to the atmosphere. The condensation of the remaining steam and the dissolution of a portion of the distillation products from the wood take place in the scrubber 9.

When the temperature in the chamber drops below 80° C., provision of water via the metering pump 6 ceases automatically and the electrically-driven flow-control valves 10 open. The steam is removed from the system chamber through one of these, and fresh air is pumped in through the other.

The thermal insulation ensures maintenance of the required temperature and minimizes heat exchange between the chamber 1 and the ambient atmosphere. The control cabinet 11 ensures the subsequent heating of the steam-gas medium within the chamber to 220° C. and maintains the temperature of the air medium for 30˜60 minutes depending on the processing program specified. During this, the wood temperature rises to 253° C. because of the exothermic chemical reaction. Water is subsequently added to the chamber by means of the injection device to provide metered water. This leads to a drop in the steam temperature over 6˜7 hours. When the chamber temperature drops below 150° C., water injection ceases automatically.

Control of the electrical heating unit, the electrically-driven flow-control valves, the injection pump, etc. is performed from the control cabinet 11 that includes an LCD display to monitor and program various processes. In addition to the above-mentioned signals from various sensors, the control cabinet also receives signals of temperature values in various points within the stack of wood being processed. Programming of control modes by the cycle is performed based on the values of the above-mentioned parameters whose attainment is a control signal to control the cycle. Switching of the power circuits is performed by means of the power cabinet (not shown in illustration).

After the processed wood within the cabinet is cooled to room temperature, the thermally-insulated door is opened, the cart with the pallet is taken out, and the finished product is unloaded.

Wood of a dark brown color and a distinctive aroma is obtained that displays the following properties:

1) Water absorption is reduced by 4 times in comparison with non-treated wood.

2) Variation in dimensions is reduced by 17 times in comparison with non-treated wood.

### IMPLEMENTATION EXAMPLE 2

Treatment of wood is performed as in example 1, but with the following parameters:
Heating in air atmosphere to 140° C.
The maximum heating temperature of wood is 210° C.
This temperature is maintained for 30 minutes.

Wood of a dark walnut color is obtained (lighter than in example 1) with the following properties:

1) Water absorption is reduced by 3 times in comparison with non-treated wood.

2) Variation in dimensions is reduced by 10 times in comparison with non-treated wood.

### IMPLEMENTATION EXAMPLE 3 (COMPARATIVE)

Wood was treated at temperatures as in example 1, but instead of water injection at 140° C., nitrogen was added from a tank until the fully-cooled stage was reached.

### IMPLEMENTATION EXAMPLE 4 (COMPARATIVE)

Wood was treated at temperatures as in example 1, but water injection was halted when the remaining oxygen content was 3˜4%.

Wood of a dark brown color was obtained with a partially carbonized surface of a black color.

Thus, wood obtained according to the claimed method possesses better properties than that obtained according to the known methods.

### INDUSTRIAL APPLICATION

Thus, as the above-mentioned data show, wood that was processed according to the group of inventions shows the following improved properties:

1) Water absorption is reduced by 2.8 times in comparison with non-treated wood.

2) Variation in dimensions is reduced by 9 times in comparison with non-treated wood.

Potential applications in construction and finishing for wood obtained according to the claimed invention are described below.
The dimensions of solid wooden WESTWOOD doors will never ‘wander’ in comparison with the conventional doors of wood chipboard, and with their price they are fully comparable in design and quality with imported Italian doors.
The euro-windows of WESTWOOD solve the ‘eternal’ problems with wooden windows: variation in dimensions and rotting from constant exposure to moisture.
Flooring of WESTWOOD wood can be laid without cracks since the dimensional variation of WESTWOOD wood has been reduced by 17 times. Production of colored wood flooring is possible based on variation of processing levels.
Wooden tiles for sanitary and kitchen facilities are now an alternative to cold ceramic tiles for floors and walls.
One-piece bathtubs and sinks of retified wood are available for sale in Paris. Unusual, beautiful, and beneficial to health.
Saunas retain their original appearance in spite of constant changes in temperature and humidity. And the scent of natural wood!
Kitchen furniture should actually be built of natural, ecologically pure materials with increased resistance to moisture and bacteria.
Garden furniture of WESTWOOD wood is practically eternal (and this without the use of harmful chemical additives!).
Exterior coverings and sidings of houses and buildings not only give the house an attractive and costly appearance, but also actually protect it from moisture, cold, and noise. Such a house need not be painted every year!
And some other applications of WESTWOOD wood: yacht hulls, paving of swimming-pool aprons, noise barriers near freeways, fences, any exterior equipment, and thousands of other applications.

Other useful properties of products made of wood similar to WESTWOOD:
Improved surface quality and total lack of problems with deposit of dust;
Most applications do not require paint
Long service life;
Significant reduction in desiccation;
Long-term resistance to pressure;
Uniform color throughout its full depth;
Resistance to high temperatures;
Increased fire resistance and thermal-insulation properties;
Distinctive aroma of natural wood;
Absolute ecological purity.

1. A method for thermal treatment of wood to improve its basic properties, including heating the wood to 140˜150° C. in ambient atmosphere, further heating of the wood in an atmosphere of wet steam to 210˜220° C., which is performed by means of constant metered injection of water into the chamber and evacuation of the air and other gases from the chamber by the wet steam formed, self-heating to 230˜240° C. in the course of 30˜60.minutes, discontinuing the self-heating by means of metered injection of water, and cooling of the wood in an atmosphere of 100% super-saturated wet steam by means of controlled injection of water, whereby the control and programming of the modes of thermal-treatment processing are accomplished using the principle of an intellectual cycle, during which control of the thermal-processing cycle is performed by the formation of directed actions corresponding to the parameters of the current information used in the form of control signals transmitted to a computer system that determines the optimal values of the process parameters.

2. The method for thermal treatment of wood as in claim 1, wherein the directed actions (control signals) correspond to the process parameters of the thermal treatment and include the temperature values of the thermal medium, the temperature of the wood at various points of the stack at inlet and outlet, the species of tree, the dimensions of the wood (and of the stack), the addition of air and water, the regulation of the feed of steam, and the duration of the process.

3. The method as in claim 1, in which the pressure of the wet steam within the chamber is 10% above the atmospheric pressure.

4. The method as in claim 1, in which the heating of the wood to 140˜150° C. in atmospheric air is performed over the course of 2˜3 hours.

5. The method as in claim 1, in which subsequent heating of the wood to 210˜220° C. in an atmosphere of wet steam is performed over the course of 2˜3 hours.

6. A device for thermal treatment of wood according to a method in claim 1 that operates on the principle of an intellectual cycle, which includes a hermetic thermally-insulated chamber positioned within a sea container and possessing a hermetically-sealable aperture through which to load the wood, connected by a connecting duct with air ducts, with a ventilator to force the air, a vaporizer and an electrical heating unit, a metering pump to add water that is connected with the vaporizer, electrically-driven flow-control valves connected with the chamber, a scrubber for the mixture of steam and air connected with the chamber by means of a hydraulic lock, a control cabinet with a computer system for control and programming of the process and controlling the electrical heating unit, the electrically-driven flow-control valves, the injection pump, the chamber provided with sensors to monitor the process parameters, and the control signals that are transmitted to the control cabinet.

7. A wood product thermally treated according to the method of claim 1.
